(19) United States
(12) Patent Application Publication
(10) Pub. No.: US 2002/0157541 A1
(43) Pub. Date: Oct. 31, 2002

(54) Temperature probe controller circuit

(76) Inventors: Pin Cheah, Dandenong (AU); David Richards, Caringbah (AU)

Correspondence Address: KLAUBER & JACKSON, 411 HACKENSACK AVENUE, HACKENSACK, NJ, 07601

(21) Appl. No.: 10/032,340

(22) Filed: Dec. 21, 2001

(30) Foreign Application Priority Data
Dec. 22, 2000 (AU) PR 2273

(51) Int. Cl. A23L 1/00

(52) U.S. Cl. 99/331

(57) ABSTRACT

A circuit for controlling the flow of electric current through a resistive element, the circuit including a relay and a solid state switch, and a microprocessor for generating control signals to direct current through the solid state switch when the magnitude of the current changes rapidly, and through the relay when the magnitude of the current is relatively stable.

### TECHNICAL FIELD

This invention relates to the temperature control of heating appliances, in particular cooking appliances.

### BACKGROUND TO THE INVENTION

Electric cooking appliances, such as electric pans and woks, allow the temperature of the appliance to be carefully controlled. This is often useful when cooking food which required precise cooking temperatures to optimise the flavour and texture of the food.

Furthermore, the use of an electric cooking appliance provides for automated control of the cooking process, in that a cooking cycle may, in some cases, be programmed to increase and decrease the cooking temperature of the appliance at preset times. This leaves the cook or chef with more time to attend to other tasks.

### DESCRIPTION OF THE PRIOR ART

The circuits used to control the temperature of the appliance involve the provision of current to a resistive element, which dissipates the energy provided as heat. The level of energy, and thus heat dissipated, is proportional to the average power delivered via the current into the resistive element. Accordingly, controlling the amount of current being delivered to the resistive element will allow for the control of heat energy being dissipated by the resistive element.

This is accomplished by “connecting and disconnecting” the load, or resistive element, to and from the current source. The ratio of the “connected time” to the “disconnected time” will determine the average power delivered to the resistive element, and accordingly determine the heat generated therefrom.

This connection and disconnection is accomplished via an electronic switch, typically a relay. A relay is a mechanical switch which is actuated via electromagnetic means, causing a conductive element to switch from one position to another, as is well understood by those skilled in the art.

Precise regulation of the temperature (amount of heat dissipated by the resistive element) requires that the switch be able to switch quickly and frequently. A problem with relays is that, being partly mechanical in nature, they have a limited life span, in that the number of times the conductive element is able to be switched before failing is limited.

Ideally, more robust switching devices would be useful in this application. Solid state switches, such as triacs, adapt themselves well to fast switching. Such devices are also well known in the art. Triacs are able to switch between one conducting state and another extremely quickly and are far more long lasting in terms of the number of “switches” that can be performed in a lifetime. However, a serious disadvantage of such solid state switches is that they themselves dissipate a significant amount of power in the form of heat, and require the use of substantial heat sinks. This is a disadvantage, particularly in the application of kitchen appliances where space is often at a premium in such appliances and heat sinks can take up valuable space. Accordingly, such devices are not generally suitable in these applications.

It is accordingly an object of the present invention to provide a temperature control circuit which is able to reduce space requirements while maintaining a longer product lifetime.

### SUMMARY OF TIE INVENTION

According to a first aspect of the present invention, there is provided a control circuit for controlling the flow of current from a current source through a resistive element, the circuit including;

a microprocessor for generating control signals;

a relay for selectively connecting a current source to the resistive element in accordance with the control signals generated by the microprocessor; and

a solid state switch for selectively connecting the current source to the resistive element in accordance with the control signals generated by the microprocessor, the control signals being generated to coordinate the switching of the relay and triac in order to reach and/or maintain a desired temperature.

Preferably, the circuit is a temperature control circuit for a heating appliance.

Preferably, the solid state switch is a triac.

According to a second aspect of the present invention, there is provided a control circuit for controlling the flow of current from a current source through a resistive element, the circuit including;

a solid state switch;

a relay;

a first comparator associated with said solid state switch and having a first threshold; and

a second comparator associated with said relay and having a second threshold, wherein a control signal is applied to an input of said circuit causing said solid state switch to turn on when the magnitude of the voltage of said control signal exceeds said first threshold and wherein the relay is in an open state when said voltage magnitude is below said first threshold and in a closed state when the magnitude of said voltage is above said second threshold.

According to a third aspect of the present invention, there is provided a method of controlling the flow of current through a resistive element, the method including the steps of;

generating control signals;

providing the control signals generated to a relay for selectively connecting a current source to the resistive element in accordance with the control signals; and

providing the control signals generated to a solid state switch for selectively connecting the resistive element to the current source in accordance with the control signals, the control signals being generated to coordinate the switching of the relay and solid state switch in order to reach and/or maintain a desired temperature.

A preferred embodiment of the present invention will now be described with reference to the following drawings.

### BRIEF DESCRIPTION OF TIE DRAWINGS

FIG. 1 shows a control circuit in accordance with a first embodiment of the present invention.

FIG. 2 shows wave form timing diagrams for the first embodiment;

FIG. 3 shows a system block control diagram for the first embodiment;

FIG. 4 shows an output flow diagram for the first embodiment;

FIG. 5 shows wave form timing diagrams for a second embodiment of the present invention; and

FIG. 6 shows a control circuit for the second embodiment.

### DETAILED DESCRIPTION OF THEE PREFERRED EMBODIMENT

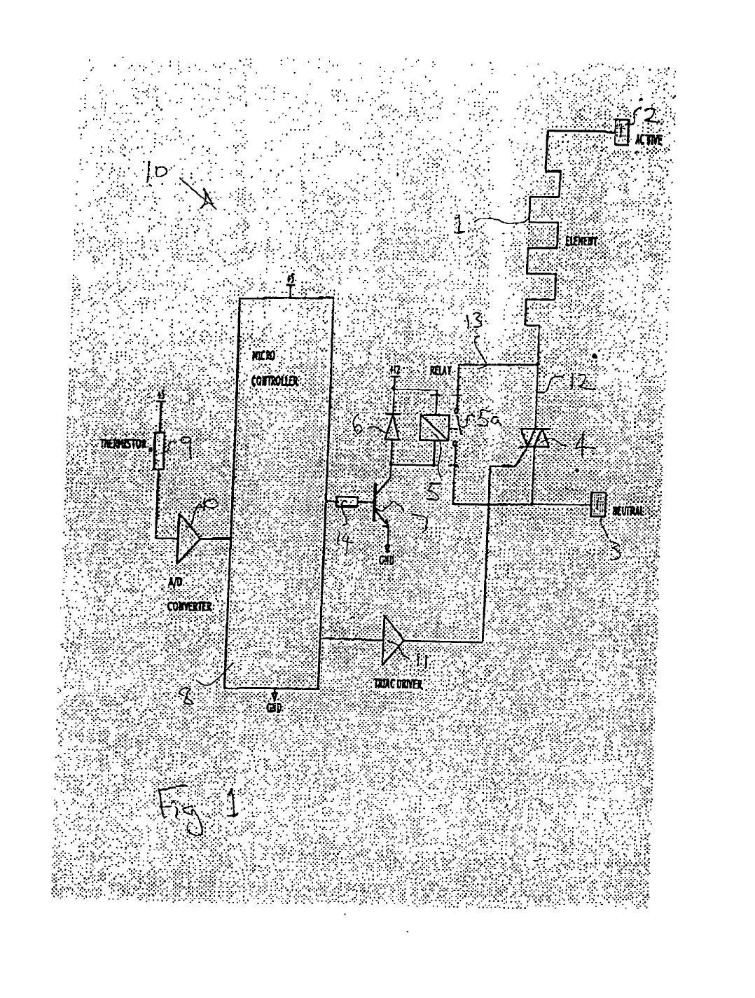

Referring to FIG. 1, it can be seen that resistive element 1 is connected between voltage source 2 and ground, or neutral point, 3. When so connected, a current i will flow through element 1. Voltage source 2 is an AC source, which causes AC current i to flow through resistive element 1. As current i flows through element 1, energy is dissipated from element 1 in the form of heat. This heat is proportional to the power which is dissipated via element 1. This power is delivered to element 1 via the current i and is proportional to the average power of that current signal. For sinusoidal current i, having a RMS current of I_{RMS}amps, the average power P dissipated through the resistive element having a resistance of R ohms, is given by the well known relation

P=I²_{RMS} R

Thus, the average power in the form of heat, generated by resistive element 1 can be controlled by varying the average EMS current being delivered to element 1.

Current i is allowed to flow through element 1 when the path from source 2 to ground point 3 is closed. The circuit 10 provides two paths for the current i to flow. Current i will flow through path 12 when triac 4 is on. When relay 5 is actuated to form a short circuit in path 13, current i will flow through path 13.

When current i flows through path 12, and accordingly through triac 4, a significant amount of heat is generated by triac 4. If the magnitude of the current is great, a substantially large heat sink will be required. If current i is in the order of 10 amps, the required heat sink will need to be able to dissipate about 12 watts. Such a requirement would normally make the use of a triac in this application unsuitable. However, in accordance with the present invention, the path taken by current i is alternated between path 12 through triac 4 and path 13 through relay 5. In some cases, however, both the triac 4 and the relay 5 may be on at the same time, providing two current paths, even if only momentarily, as will be described in more detail further below.

In contrast, relay 5 does not dissipate an appreciable amount of heat, regardless of the magnitude of current flowing through its conductive element 5a.

To optimise the working of the circuit 10, microcontroller 8 calculates and generates control signals to open triac 4 and close relay 5 such that current i flows through path 13 for current flows of long duration. Triac 4 however is used to take the load current momentarily to avoid contact splash, thus enhancing the relay life. Accordingly, in these instances, Micro-controller 8 generates signals to close triac 4 and open relay 5, causing current i to flow through path 12. In instances where more rapid switching is required, again, triac 4 is used in preference to relay 5. In this way, large average RMS currents having greater average power will go through path 13 via relay 5 which does not dissipate appreciable amounts of heat, while instances requiring fast switching and lower current power will make use of triac 4. Tis way, relay 5 is spared from having to switch on and off quickly and a greater number of times, while at the same time, the power dissipated by triac 4 will be reduced because only low powered current will flow therethrough. Accordingly, any heat sinks required by triac 4 will be far smaller than otherwise required.

To actuate relay 5, micro-controller 8 will generate a signal to cause transistor 7 to conduct, by applying a voltage at the base of transistor 7 through resistor 14. Diode 6 provides a typical protection against the emf currents generated by the coil of relay 5. To switch triac 4 on and off, micro-controller 8 will generate a control signal to triac driver 11, which will actuate triac 4.

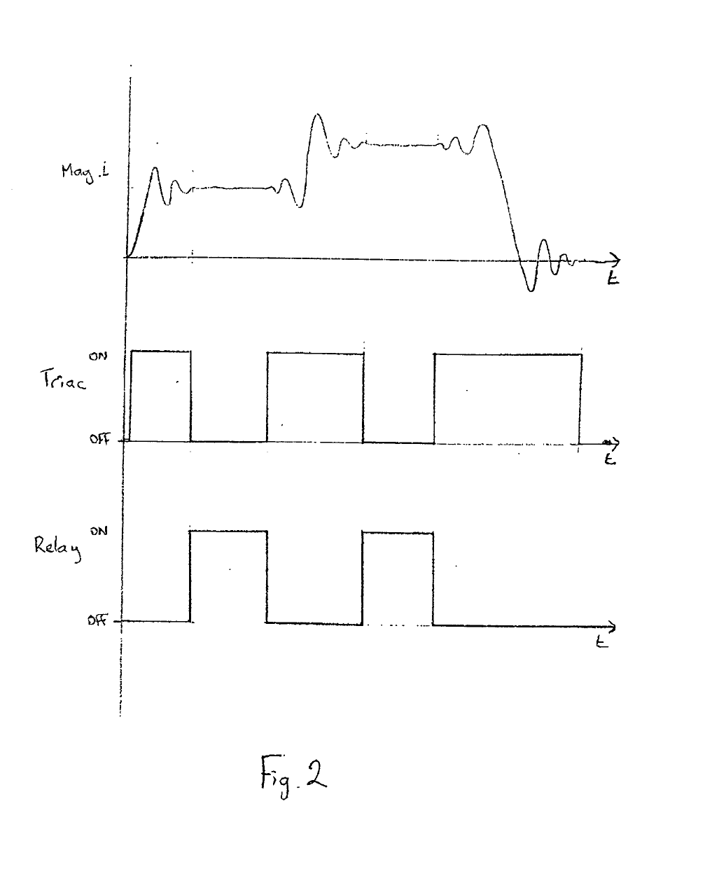

Exemplary timing and wave form diagrams illustrating the above are shown in FIG. 2.

The input to micro-controller 8 is provided by thermistor 9 which will provide a signal proportional to temperature sensed by thermistor 9. This analogue signal is converted to a digital signal by A/D converter 10 for input to micro-controller 8.

The control signals generated by microcontrollers are generated in accordance with a control algorithm, which uses PIE) control principles to effectively maintain a desired temperature of the appliance.

For example, if thermistor 9 detects a sudden drop in the temperature of the appliance (which may happen if food is added to the pan for example), micro-controller 8 will generate signals to coordinate the switching of relay 5 and triac 4 to immediately provide a high current surge through element 1, creating additional heat. This works in a predictive manner in that upon detecting a sudden temperature drop, micro-controller predicts the further reduction of temperature from the rate of the initial fall, and generates the appropriate control signals to compensate. This allows for fast and dynamic temperature regulation.

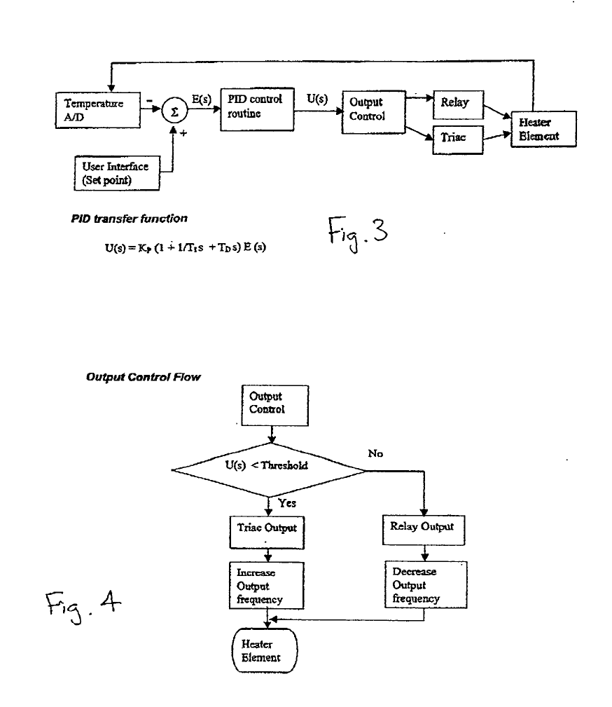

Turning now to FIG. 3, there is shown a block diagram of the control system used to calculate and generate control signals for the triac 4 and relay 5. The PID transfer function is again by:

U(s)=Kₚ(1+1/T₁ s+T_{D}s)E(s)

The transfer function is a Laplace transform of the standard differential equations representing the PID equation, where:

U(s) is the control output calculated by the PID transfer function.

E(s) is the error input to the transfer function, which is usually a difference of the sensed parameter with respect to the desired set point

Kₚ is the Proportional Gain

T_{I} is the Integral time

T_{D} is the Derivative time.

Kₚ, T_{I} and T_{D} are adjusted to provide the desired response of the controller as is well understood in the art.

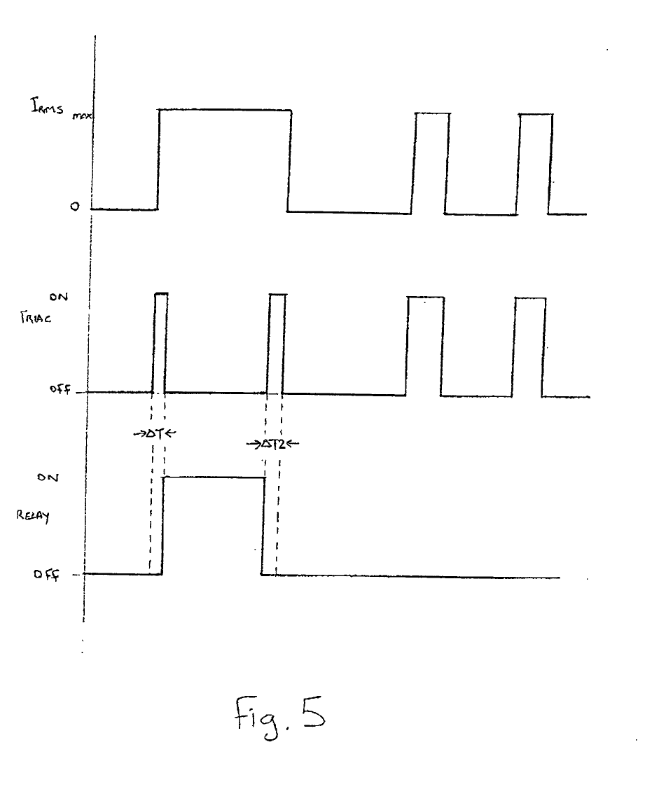

FIG. 4 shows the output flow which represents the algorithm used to convert the output of the PID transfer U(s) to the control signals for the triac 4 and relay 5. The decision block “U(s)<Threshold” provides a simple mechanism for selecting between the relay 5 and triac 4 outputs, which controls the average power through element 1. The output frequency is also increased with triac activation.

While perhaps not as effective as the embodiment described above, it is also possible to control the operation of the relay 5 and the triac 4 together rather than independently.

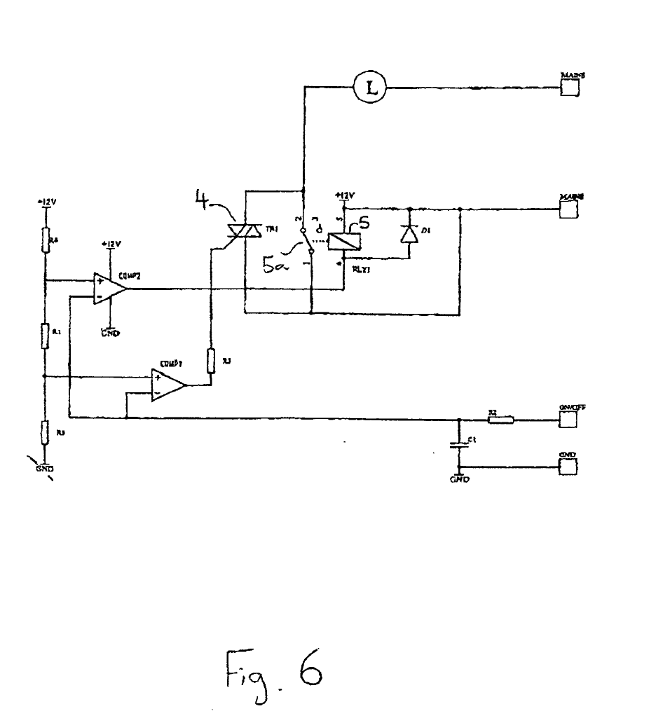

In this embodiment, (see circuit in FIG. 6) the triac 4 is caused to switch on just before the relay contact 5a closes, and is turned off just after relay contact 5a opens. In this way, the relay contact 5a is not stressed because it does not have current passing through it at times when the magnitude of the current changes rapidly. As discussed previously, fast switching causes excessive bouncing of contact 5a and can cause contact arcing which may weld the contact 5a to the relay 5.

As shown in FIG. 6, the triac 4 and relay 5 are connected in parallel. A first comparator (comp 1) drives triac 4, while a second comparator (comp 2) drives relay 5. A signal is input to the on/off input which can be either analog or pulse width modulated. If the voltage at this signal does not rise above the threshold of comparator 1 (as set by R3/R1, R4) only triac 4 will turn on. If the voltage rises above a second threshold (as set by R4/R1, R3) then the relay will switch on. The result is that if the relay 5 does switch on, it will always do so after triac 4 switches on.

Thus at the times of fast changing current magnitude, triac 4 comes on first and then at a time ΔT later, relay contact 5a closes to provide an additional path for the current i, thereby bypassing the current away from the triac and through the relay contacts. Since the voltage across the relay contacts is lower than that across the triac, the triac will turn off, thus returning the triac to a zero power dissipation condition. When a reduction in load power is required (as sensed by the temperature sensor) the relay contacts will open, enabling current to be bypassed back through the triac for a short time. The triac is then either turned off or pulsed on and off at a low duty cycle without the relay contacts engaging, as long as the average power dissipated by the triac is well below its dissipation limit.

The triac thus enables a low switching voltage across the contacts by current transfer, and allows the load current to be pulsed for a short time at high rates without relay operation.

The timing diagram for this is shown in FIG. 5. There is a delay of ΔT after the triac switches on for relay closure and a delay of ΔT₂ for the triac to turn off after the relay contacts open. ΔT₂ is biased by usual triac action and cannot turn off until the current passing through the triac goes to zero, ie for a 50Hz sinusoid at the zero crossing point.

It will be appreciated that the above has been described with reference to a particular embodiment and that many variations and modifications may be made within the scope of the present invention.

The claims defining the invention are as follows:

1. A control circuit for controlling the flow of current from the current source through a resistive element, the circuit including:
a microprocessor for generating control signals;
a relay for selectively connecting a current source to the resistive element in accordance with the control signals generated by the microprocessor; and
a solid state switch for selectively connecting the current source to the resistive element in accordance with the control signals generated by the microprocessor, the control signals being generated to coordinate the switching of the relay and triac in order to reach and/or maintain a desired temperature.

2. A control circuit according to claim 1 wherein the control signals cause the relay and solid state switch to coordinate such that said current passes through said solid state switch when the magnitude of said current changes rapidly, and passes through said relay when the magnitude of said current is relatively constant.

3. A circuit according to any one of claims 1 or 2 wherein said solid state switch is a triac.

4. A circuit according to any one of claims 1 to 3 wherein said circuit is a temperature control circuit for a heating appliance.

5. A control circuit for controlling the flow of current from a current source through a resistive element, the circuit including;
a solid state switch;
a relay;
a first comparator associated with said solid state switch and having a first threshold; and
a second comparator associated with said relay and having a second threshold, wherein a control signal is applied to an input of said circuit causing said solid state switch to turn on when the magnitude of the voltage of said control signal exceeds said first threshold and wherein the relay is in an open state when said voltage magnitude is below said first threshold and in a closed state when the magnitude of said voltage is above said second threshold.

6. A circuit according to claim 5 wherein said solid state switch is a triac.

7. A method of controlling the flow of current through a resistive element, the method including the steps of;
generating control signals;
providing the control signals generated to a relay for selectively connecting a current source to the resistive element in accordance with the control signals; and
providing the control signals generated to a solid state switch for selectively connecting the resistive element to the current source in accordance with the control signals, the control signals being generated to coordinate the switching of the relay and solid state switch in order to reach and/or maintain a desired temperature.

8. A method according to claim 7 wherein said control signals cause the relay and solid state switch to coordinate such that said current passes through said solid state switch when the magnitude of said current changes rapidly, and to pass through said relay when the magnitude of said current is relatively constant.

9. A method according to any one of claims 7 or 8 wherein said solid state switch is a triac.
